(19) United States
(12) Patent Application Publication
(10) Pub. No.: US 2026/0199167 A1
(43) Pub. Date: Jul. 16, 2026

(54) Systems and Methods To Induce And Measure In Body Compartments Harmonized And Phased Infrasonic And Sonic Range Musical Vibrations

(71) Applicants: Kim H. Manwaring, Orlando, FL (US); Scott C. Steffensen, Minneola, FL (US)

(72) Inventors: Kim H. Manwaring, Orlando, FL (US); Scott C. Steffensen, Minneola, FL (US)

(21) Appl. No.: 19/451,218

(22) Filed: Jan. 16, 2026

Related U.S. Application Data
(60) Provisional application No. 63/746,045, filed on Jan. 16, 2025.

(51) Int. Cl. A61H 1/00; A61H 23/02

(52) U.S. Cl. CPC A61H 1/005; A61H 23/0236; A61H 2201/0149; A61H 2201/0192; A61H 2201/5002; A61H 2201/5007; A61H 2201/5058; A61H 2203/0431; A61H 2205/081

(57) ABSTRACT

Infrasonic musical vibrations may be induced into various compartments of the body for therapeutic purposes, ranging from relaxation to arousal or focus, but also specifically activating physiologic responses due to vibration sensitive receptors in these spaces. These include vibration of the wall of the enteral track to control appetite, vibration of the effacing cervix to augment the birthing reflex, augmentation of bladder urge control in training against incontinence, and inducing relief from craving in relapse prone individuals with various addictions. Exemplary embodiments facilitate induction of such harmonized and phased oscillations in a seated embodiment, and also their measurement at target locations as an integrated, individualized method for treatment.

### CROSS-REFERENCE TO RELATED APPLICATIONS

This application claims priority to, and the benefit of, U.S. Provisional Patent Application Ser. No. 63/746,045 filed Jan. 16, 2025 entitled “Systems and Methods To Induce And Measure In Body Compartments Harmonized And Phased Infrasonic And Sonic Range Musical Vibrations.” The foregoing application is hereby incorporated by reference in its entirety for all purposes, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates generally to vibration therapy, and more specifically to devices and methods for inducing and characterizing the same.

### BACKGROUND

Vibration therapy for therapeutic purposes has been pursued previously; however, various shortcomings of prior approaches have not previously been overcome. Accordingly, improved systems and methods relating thereto remain desirable.

### SUMMARY

The contents of this section are intended as a simplified introduction to the disclosure and are not intended to limit the scope of any claim. The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be exemplary in nature and non-limiting.

In various exemplary embodiments, a C spring therapy chair system comprises: a seat coupled to a base via a C spring, the seat vibrationally isolated from the C spring; a first low frequency effector (LFE) coupled to a first side of the seat; a second LFE coupled to a second side of the seat, the first and second LFE positioned so as to be proximal to the ischial spines of the sacrum when a human subject is seated in the seat; a magnet coupled to a first side of the C spring; and a pickup coupled to a second side of the C spring.

The system may further comprise a pair of handles coupled to the second side of the C spring, the pair of handles configured to allow the human subject to narrow and widen a gap between the magnet and the pickup via application of force to the handles when seated in the seat.

The system may further comprise a piezo sensor mounted on a headband, the headband configured to be worn by the human subject during operation of the system to measure an effect of vibration of the seat on the human subject.

The LFEs may be configured to induce constructive and destructive interference waveforms into the seat, and the seat imparts these effects into the seated human subject. The LFEs may be configured to be driven (i) by single frequencies to create a summating interference effect, and (ii) by 2-4 further frequencies straddling the infrasonic to auditory sonic range of 5 Hz to 100 Hz, creating patterns of chord structure. A parallel path of amplitude modulation into the chair from the LFEs may be induced using the magnet and the pickup by narrowing or strumming an aperture of the C spring.

In another exemplary embodiment, a method comprises: utilizing a c spring therapy chair system to induce chorus vibration at a portion of the body of the human subject, wherein the induced chorus vibration has a therapeutic effect.

The therapeutic effect may be at least one of: suppression of appetite through the humeral (endocrine) pathway, suppression of appetite through the vagal nerve pathway, augmenting the birthing reflex, bladder training, or reduction of addicted craving.

The method may further compris using (i) a computer based real time visual rendering of patterns of traversing phased chorus waveforms at the portion of the body, and (ii) the human subject's interactive engagement with the system, to provide at least of one of local or remote feedback to the human subject during operation of the system.

The chorus vibration at the portion of the body may be measured with at least one of an accelerometer, piezo sensor, or magnetometer. The chorus vibration may be a major chord. The chorus vibration may be a minor chord. The chorus vibration may be perceived and measured through a combination of infrasonic and auditory sonic energy transmission pathways through the body of the human subject, including stretch mechanoreceptors in skin, muscles, joints, tendons, visceral organ linings, and bone conduction to the cochlea.

### BRIEF DESCRIPTION OF THE DRAWINGS

The accompanying drawings are included to provide a further understanding of the present disclosure and are incorporated in, and constitute a part of, this specification, illustrate various embodiments, and together with the description, serve to explain exemplary principles of the disclosure.

FIGS. 1A, 1B, 1C, and 1D illustrate lateral, posterior, anterior, and superior views, respectively, of a C spring therapy chair in accordance with various embodiments;

FIG. 2A illustrates attachment of low frequency effectors (LFEs) beneath the location of the ischial spine in a seated subject, in accordance with various embodiments;

FIG. 2B illustrates a truncated lower organ or piano keyboard with associated frequencies;

FIG. 3A illustrates a subject seated on an exemplary C spring therapy chair, in accordance with various embodiments;

FIG. 3B illustrates temporal swells when the left and right LFEs are driven at 25 and 26 Hz respectively, in accordance with various embodiments;

FIG. 3C shows the associated FFT spectrogram for FIG. 3B, in accordance with various embodiments;

FIG. 3D shows a pattern of chorus which straddles the infrasonic to sonic range when the LFEs are driven with a dominant major chord of G B D, in accordance with various embodiments;

FIG. 3E shows the minor G flat diminished fifth with G B flat D flat, in accordance with various embodiments;

FIG. 3F shows the strident pattern of G A flat G A flat, in accordance with various embodiments;

FIG. 4A illustrates a lateral view of an exemplary C spring therapy chair, in accordance with various embodiments;

FIG. 4B illustrates an augmented pattern from constructive interference, in accordance with various embodiments;

FIG. 5A illustrates a wearable headband as part of a C spring therapy chair system, in accordance with various embodiments; and

FIG. 5B illustrates simultaneous tracings of induced swells in a seat of an exemplary C spring therapy chair, and detection of a traversed waveform in the head, in accordance with various embodiments.

### DETAILED DESCRIPTION

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical, chemical, electrical, communicative, or mechanical changes may be made without departing from the spirit and scope of the disclosure. Thus, the detailed description herein is presented for purposes of illustration only and not of limitation.

For example, the steps recited in any of the method or process descriptions may be executed in any suitable order and are not necessarily limited to the order presented. Furthermore, any reference to singular includes plural embodiments, and any reference to more than one component or step may include a singular embodiment or step. Also, any reference to attached, fixed, connected, coupled, or the like may include permanent, removable, temporary, partial, full, and/or any other possible attachment option. Additionally, any reference to without contact (or similar phrases) may also include reduced contact or minimal contact.

In accordance with principles of the present disclosure and various embodiments, the audible musical spectrum is generally considered to range from 20 Hz to 20 kHz in young human adulthood, but deteriorating at both ends of the spectrum with aging, disease, and injuries. Sound can be perceived by at least the following pathways to the brain: (i) auditory (air conduction) transduced and forwarded to the cochlea and auditory nerve, (ii) exterororeceptive by skin mechanoreceptors such as Meissner and Pacinian types, (iii) interoceptive sensing by stretch and vibration receptors such as in tendonous and muscular sheaths and in the walls of visceral organs like stomach and bowel, and/or (iv) bone conduction pathways to the cochlea.

Infrasonic sound is vibration below the level of auditory perception, and its spectral range varies by age, location of vibrations, and amplitude. Sound origin, infrasonic or in normal auditory range, can be localized. Waveforms and combination with resulting interaction of waveforms can affect localization of maximum sound by phasing at least two sources in well described methods of destructive and constructive interference. Sound frequencies, from infrasonic through normal auditory range, can harmonized by producing patterns of simultaneously produced chordal structures of two or more sounds in major and minor patterns but also modified in tempo and rhythmicity. For example, the pipe organ has the widest infrasonic to auditory pitch range. The diapason pipes can thus induce music which is heard, but also particularly felt. Such felt vibrations can harmonize and thus augment perception associated with relaxation, arousal, distress, and even fear in the brain. For example, major chords activate functional imaging of the brain in areas which are associated with a sense of well-being and control. Discordant, minor, and/or strident combinations can activate the brain in patterns known to be associated with fear and anxiety. Similarly, such chords traversing from seat actuators up the spine have been recently shown to activate paraspinal stretch mechanoreceptors which in turn can increase dopamine secretion in the nucleus accumbens, associated with feelings of reassurance or control, augmenting ability to suppress panic.

Yet alternatively, pulsed infrasonic frequencies from a seat can create a physiologic intense sense to void or to defecate. Further, enterally transmitted sounds can vibrate the stomach wall as a function of intensity, creating a sense of fullness, suppressing appetite. At high amplitudes, such vibration can even induce nausea.

A further illustrative example is the augmentation of the Ferguson reflex in childbirth, the so-called fetal expulsive reflex, which is induced by the pushing down descent of the fetal head upon the effacing cervix, triggering pulses of oxytocin in the brain, but also neural pathways to strengthen uterine contraction and volitional bearing down. Seat originating infrasonic vibrations can further enhance that positive feedback loop.

A recruitment of the musical chorus effect from infrasonic to normal range can coordinate various pathways of perception and result in the so-called musical thrill, an exhilarating and sometimes overwhelming emotional perception, which is well known in certain contexts such as the Hallelujah Chorus or intense automotive videogaming.

Individuals vary widely in their sensitivity due to activation of infrasonic and audible pathways and patterns. When a seat-embodied infrasonic range device is employed to induce or augment a physiologic effect in the body, it is therefore very desirable to measure the pattern and amplitude of the transduced effect at such targets. It is further desirable to enable the individual to modify the amplitude or chorus effects as objectively measured or subjectively perceived to optimize the therapeutic benefit. This also enables a training environment toward therapeutic goals with high replication potential of each session. As examples of measurement of the induced physiologic effect, several examples follow.

An embodiment of seated subject with induction of an infrasonic and audible wave for control of craving in a subject dealing with alcohol or opioid addiction may include a wearable cap which measures through a piezo, magnetometer, accelerometer, or other suitable transducer the infrasonic and normal auditory phased wave as it traverses from sacrum to cranium. The cap may include other physiologic transducers including a pulse plethysmography sensor for heart rate (HR) and heart rate variability (HRV) measurement. It may also include paired electrodes for measurement of skin conductivity (electrodermal reflex EDR). The cap thus provides means to characterize a treatment session by duration, amplitude, and effects on HR, HRV, and EDR known to be associated with self-regulation and recovery of self-control. The subject can also turn an amplitude knob to adjust the intensity. The treatment session can be visually augmented by a computer which renders a ball which traverses vertically on the screen based on strength of the amplitude and location. Moreover, a therapist can remotely monitor the patient and can provide verbal guidance during the training session.

During stage 2 delivery of a fetus the seated mother can be instrumented with a fetal scalp electrode which incorporates a static toroidal magnet to emit a field. A magnetometer placed over the mother's symphysis pubis or dorsal sacrum provides mother both a visual and auditory rendering of the baby's descent position, but also the effect of each contraction pushing the head down upon and through the cervix. The accelerometer sensor incorporated with the magnetometer can detect the amplitude of the induced chorus swells of vibration from the birthing seat into her cervix. The mother can grasp the handle bars at the side of the seat, move forward and downward in a squatting position and volitionally strengthen the effect of the fetal expulsive reflex. This maneuver augments the chorus vibration by engaging a positive feedback loop in the seat C spring design.

The obese individual can sit just prior to eating for 30 minutes on the chair which will induce a chorus of vibrational swells into the viscera, particularly the wall of the stomach where known stretch receptors can be activated to suppress hunger through both the humeral (endocrine) and the vagal nerve pathways. By pulling down on handle bars to augment the vibrational amplitude and pattern, the subject can find a zone of subjective augmented fullness, associated with an afterglow period of diminished appetite.

A postpartum mother dealing with typical post vaginal delivery incontinence can sit upon the same chair with a moderately full bladder which filling size can be documented by ultrasound imaging. As the swells of chorus vibration are induced into the visceral pelvic peritoneum, the dome of the bladder can be seen to elevate with such oscillations, changing from round to globular in configuration. Mother can use the same handlebars to pull down and augment the strength of vibrations while squeezing volitionally the sphincter muscles which prevent leakage. She may also be instrumented with EMG sensors and pressure transducers in well-known strategies to characterize her progress as well as wetness sensors with leakage breakthrough of urine. The feedback loop of just enough vibration to avoid leakage becomes a practical means toward strengthening the pelvic floor and recovering continence.

While these examples of induced patterns of chorus swell in the infrasonic-sonic range are meant to be illustrative of this novel treatability of disease-oriented therapeutic targets, exemplary devices and methods disclosed herein are adjustable for amplitude, duration, pattern, and harmonic components, with both objective and subjective measurement of the desired effect. The drawings and descriptions further clarify these embodiments. The drawings and graphs show implementation of exemplary methods of a seat-based chorus effector into the body and various sensing methods to guide the subject and clinician toward a therapeutic target. Various applications illustrate this breadth.

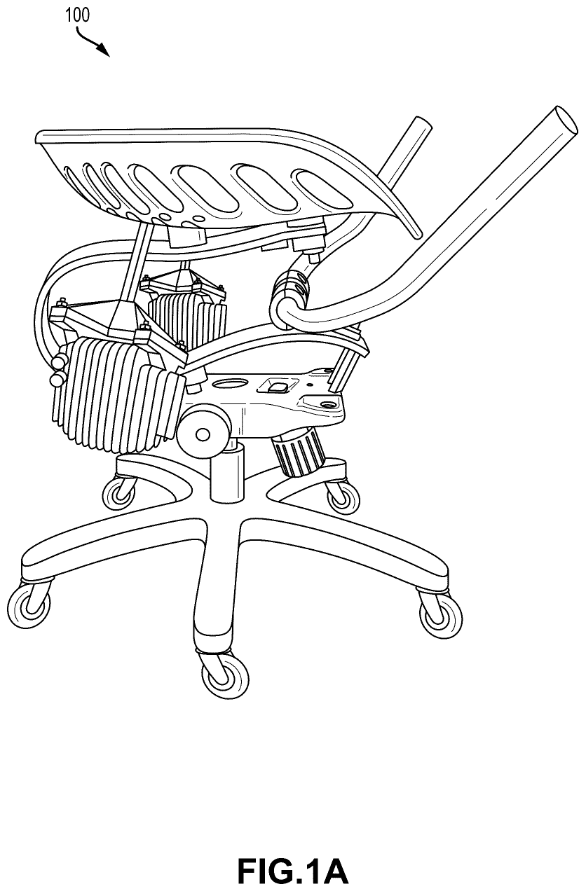

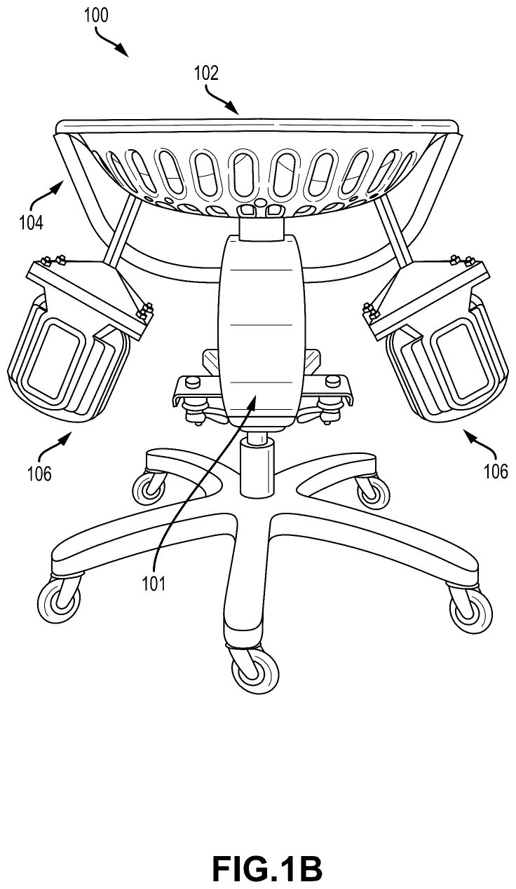

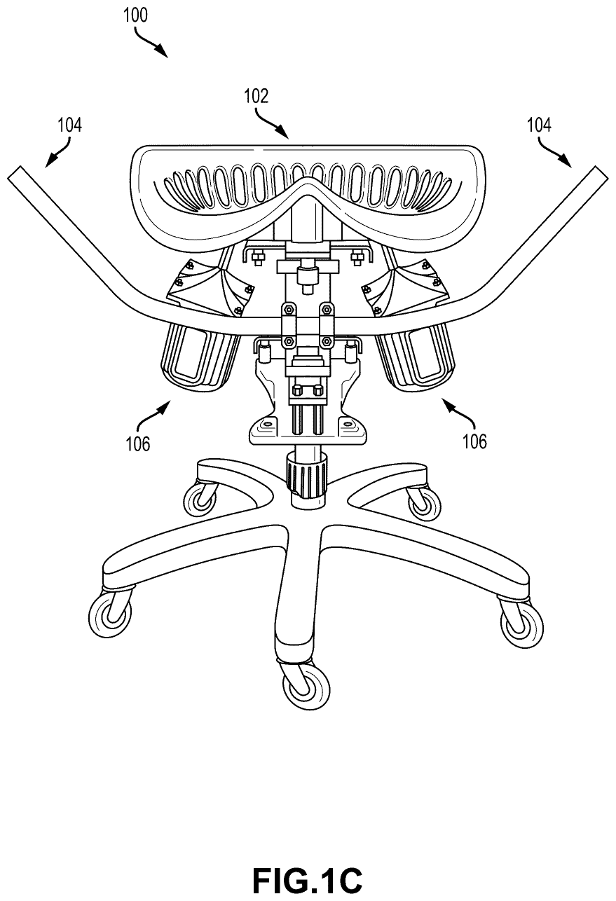

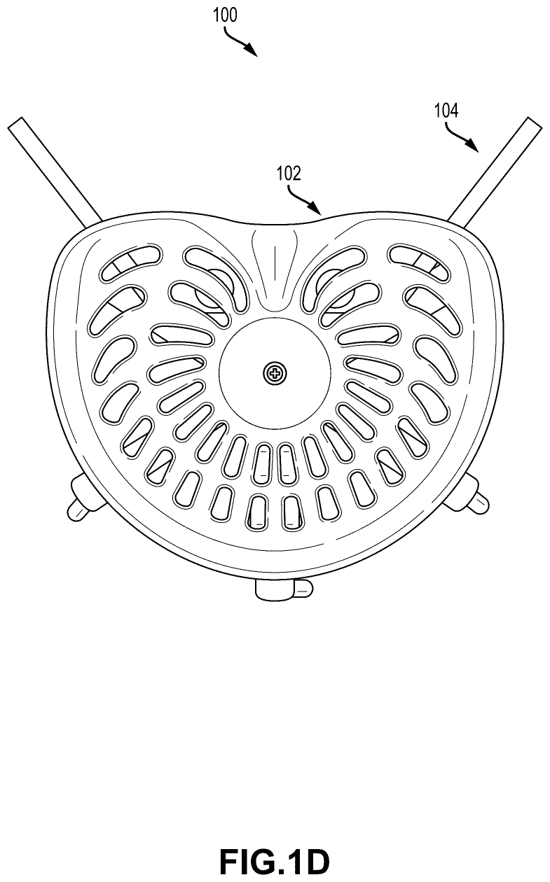

With reference now to FIGS. 1A, 1B, 1C, and 1D, an exemplary embodiment of a C-spring therapy chair system 100 is illustrated, having the form of an infrasonic-sonic range chorus inducing seat with noted C spring configuration and mounted low frequency effectors 106. Also shown are handlebars 104 which can be grasped by the seated subject to pull forward and thus narrow the aperture between a static magnet 112 on the upper side of the C spring 101 and a pickup 110 (e.g., bass guitar or similar) on the lower side of C spring 101. A tractor seat 102 or similar rigid seat is configured through kinetic (or vibrational) neoprene isolators upon a so-called C spring structure and the C spring 101 is secured to a chair base, stem, and wheels. Side, front, top, and back views illustrate attachments of bilateral, symmetric low frequency effectors (LFEs) 106, ideally placed so as to be most proximal to the ischial spines of the sacrum when a subject is seated in the chair. The C spring configuration of system 100 enables a subject to bounce or to scoot forward to narrow the aperture of C spring 101. This functional spacing enables a weight range of the subject from about 75 pounds to about 300 pounds in an exemplary embodiment. However, lower and/or higher weight ranges may be accommodated, for example via sizing of seat 102, via modification of the dimensions and spring characteristics of C spring 101, and/or the like.

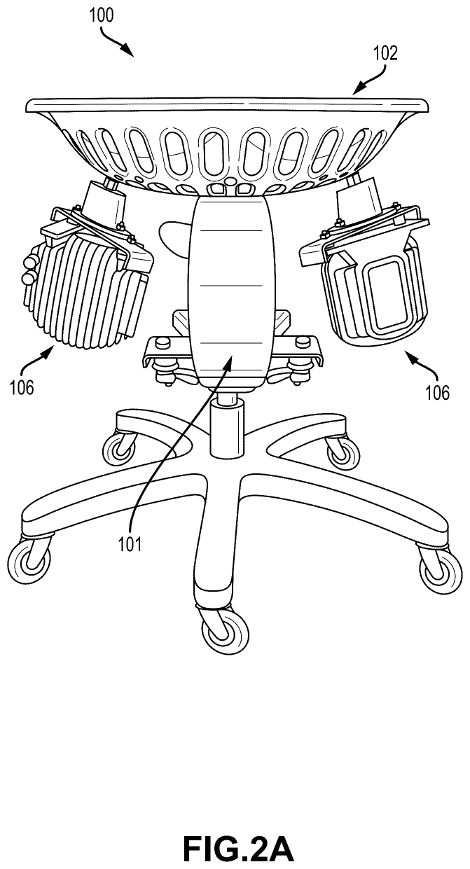

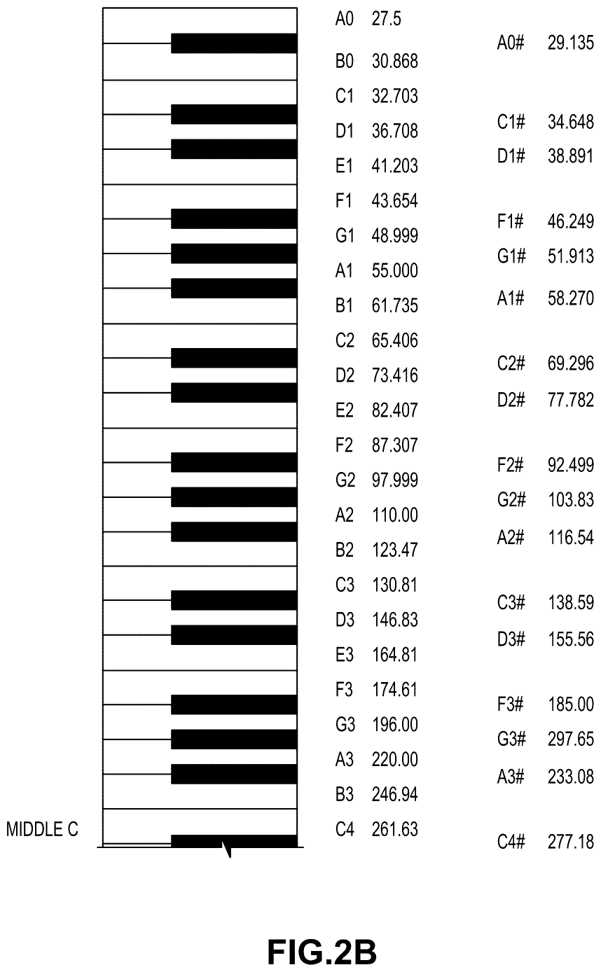

With reference now to FIGS. 2A and 2B, in various exemplary embodiments an exemplary C spring therapy chair device 100 uses driven fundamentals in the infrasonic range, e.g. GO is about 25 Hz. The low frequency effectors (LFEs) 106 (also known as bass shakers) transduce in the frequency spectrum from about 5 Hz to about 100 Hz as nondisplacement devices, inducing sinusoidal and harmonized frequencies into seat 102 below the seated subject. Seat 102 then transfers the summated, phased waveforms into the seated subject. While a wide range of frequencies can be employed from about 5 Hz to about 100 Hz, exemplary embodiments preferably drive the pair of LFEs 106 at between about 24 Hz-26 Hz infrasonic range of the fundamental with induced, associated harmonics. Constructive and destructive interference patterns are induced into seat 102 through: (i) phasing, for example 0 degrees to 180 degrees at 25 Hz, and/or (ii) by beat frequency effect, typically using 25 Hz and 26 Hz range. Alternatively, sound compression or distraction (the Haas effect) can be employed to shift one LFE frequency against another up to 1.5 semitones, resulting again in a summated beat effect in seat 102, which is then transmitted to the seated subject. Exemplary embodiments of system 100 demonstrate success with the Haas effect utilizing the Mr. Black brand guitar effects pedal Double Tracker (Black Ltd., Portland, Oregon.) However, any suitable electronic and/or electromechanical components may be utilized for these purposes, as desired.

FIG. 2B illustrates a constrained keyboard range from infrasonic to sonic, 5 Hz to 100 Hz. In various embodiments, harmonizing frequencies can be imposed into each LFE to create dominant, minor, or augmented chords ranging from 2 to 4 further notes up to 100 Hz. For example, the chord G major G0-B0-D1-G1 over the infrasonic to sonic range includes approximately 25 Hz, 31, 37, and 50 Hz. A beat frequency in the 2nd LFE may be achieved by simultaneous rendering 26, 32, 38, and 52 Hz. The subject experiences a harmonized or chorus traveling wave from sacrum to head, lateral oscillating out of phase and vertically oscillating in phase. A minor chord from infrasonic to sonic can be G minor with frequencies of approximately 25, 29, 38, and 50 Hz. A strident, distinctly unpleasant chord can be created by GO and GO sharp or other semitone pairs, approx. 25 Hz and 26 Hz. It will be appreciated that various combinations of harmonized and/or dissonant frequencies may be utilized, as desired, depending on the desired effect on the subject.

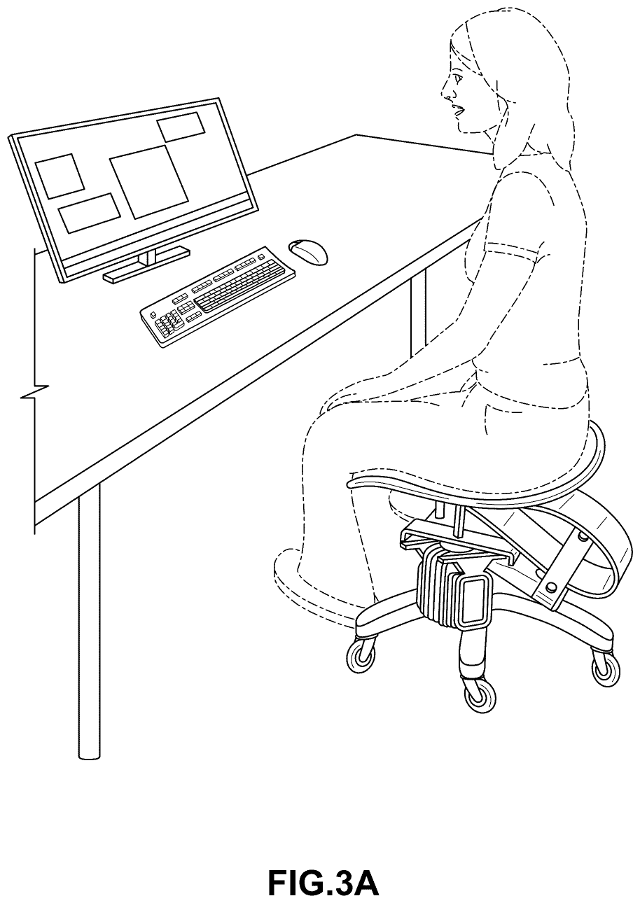

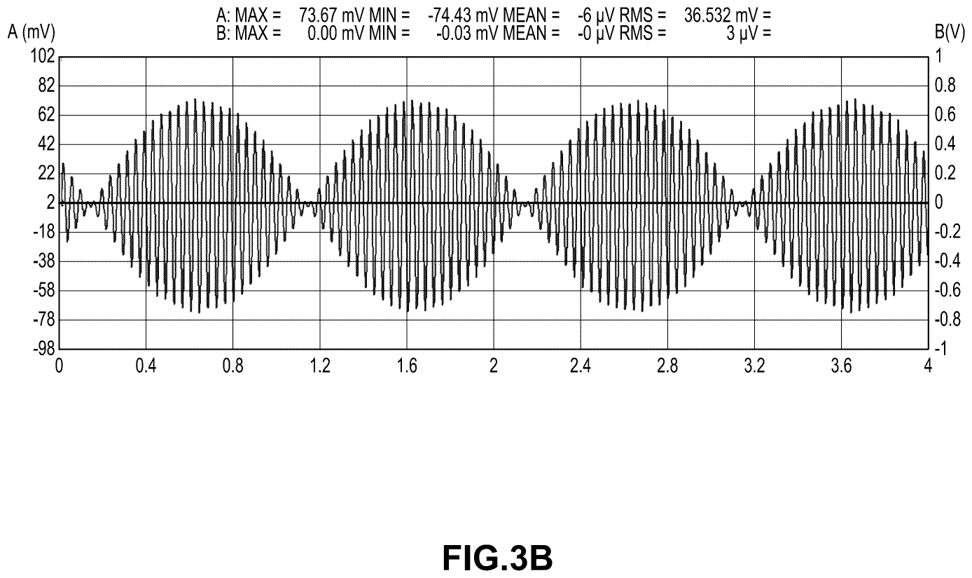

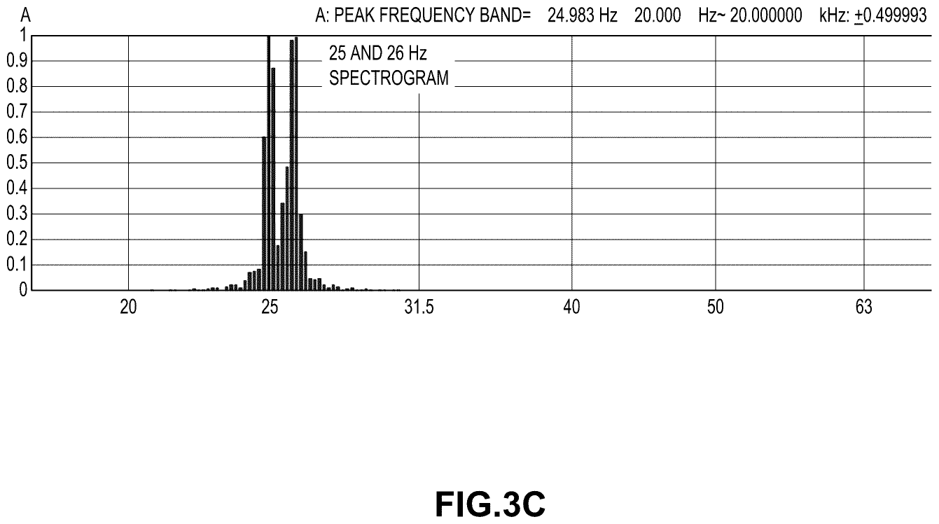

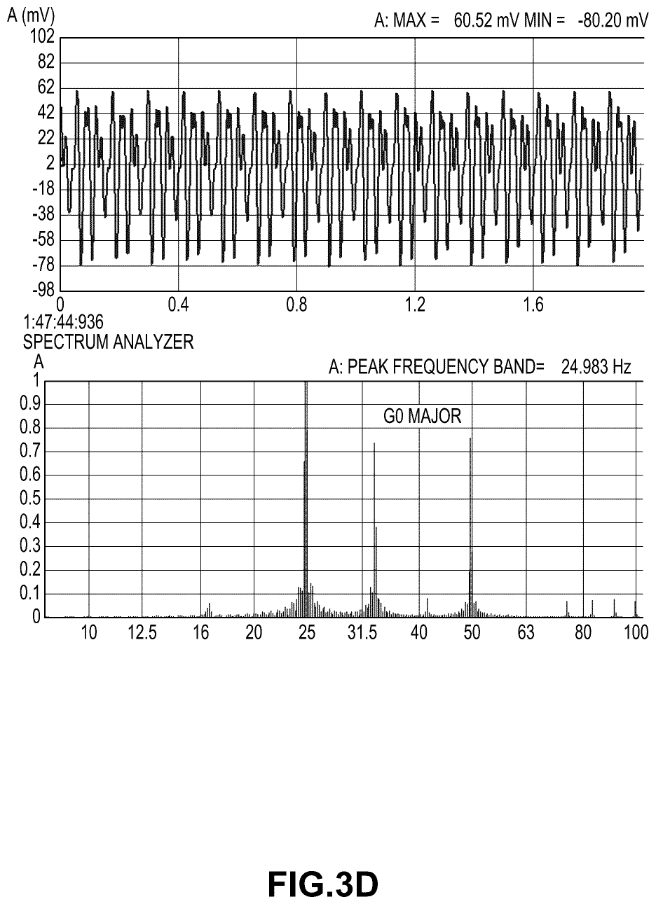

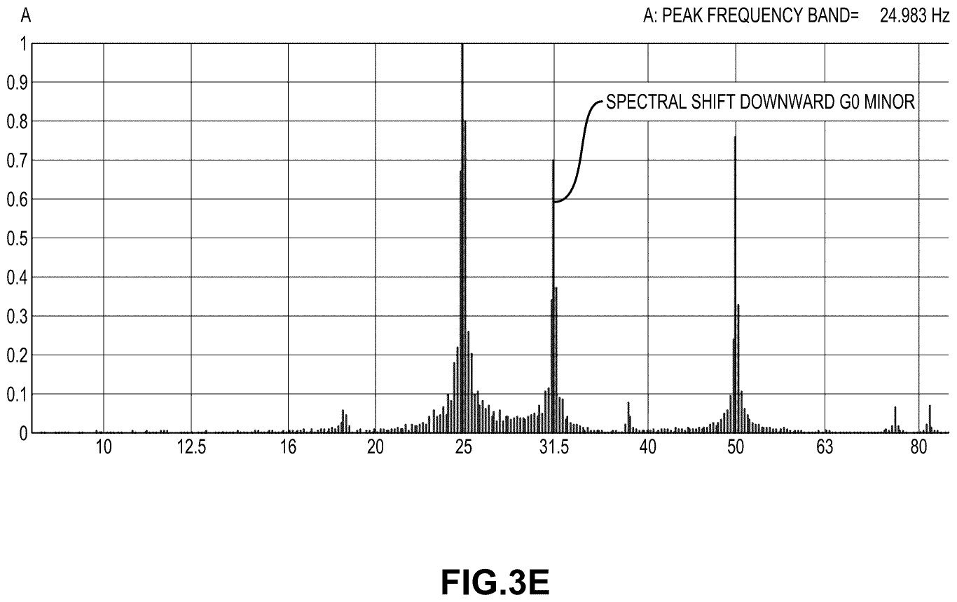

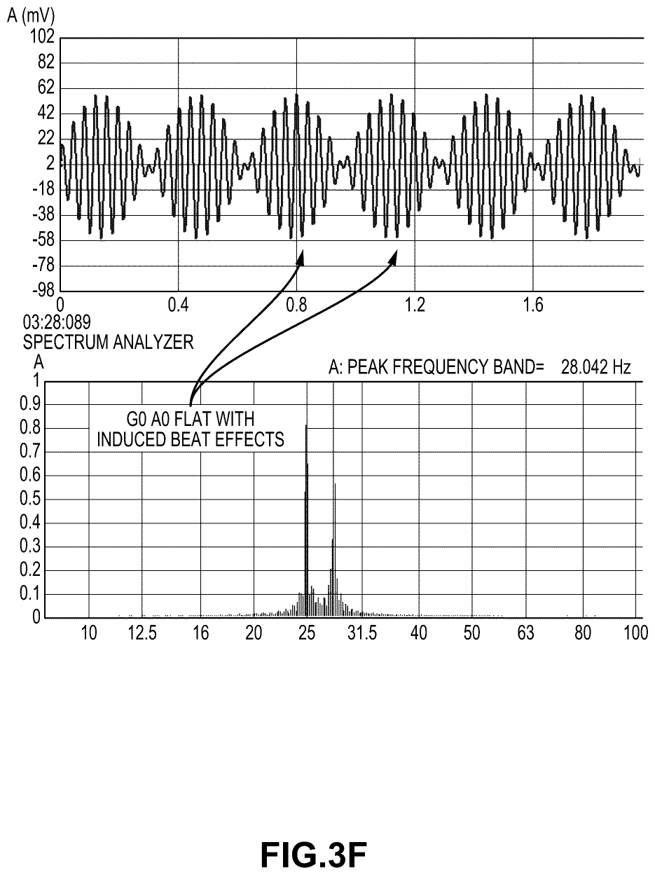

Turning now to FIGS. 3A, 3B, 3C, 3D, 3E, and 3F, and in various embodiments, when a subject sits on an exemplary C spring therapy chair system 100 and the system is operated, a pattern of infrasonic swells is experienced into the buttocks and upwards into the body of the subject. FIG. 3A shows a seated subject. FIG. 3B shows temporal swells when the left and right LFEs 106 are driven at 25 and 26 Hz respectively. FIG. 3C shows an associated FFT spectrogram. A similar pattern is seen at 25 Hz when phase shifting over 1 second from 0 to 180 degrees and back or when using sound compression. FIG. 3D shows a pattern of chorus which straddles the infrasonic to sonic range when the LFEs 106 are driven with a dominant major chord of G B D; this is associated with a relaxing or pleasurable feeling with frequency components above 40 Hz range often quietly audible. FIG. 3E shows the minor G flat diminished fifth with G B flat D flat. This is associated with an unpleasant or tension related perception. FIG. 3F shows the strident pattern of G A flat G A flat which delivers a perception that is reported to be unpleasant, but alerting.

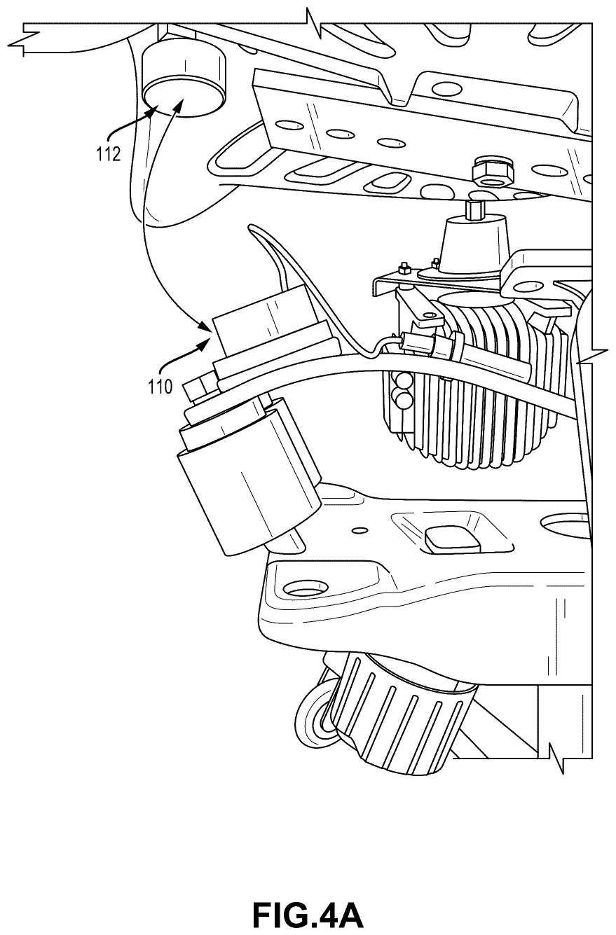

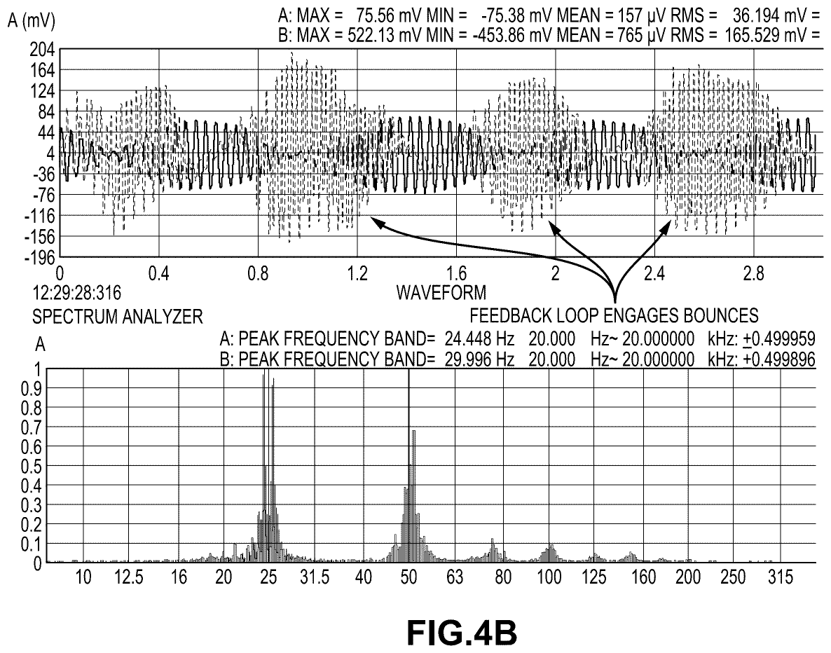

With reference now to FIGS. 4A and 4B, in accordance with various embodiments, FIG. 4A shows a lateral view of an exemplary C spring chair system 100 which shows the open aperture of the C spring 101. Beneath the horn of seat 102 is affixed a 2.5 cm cylindrical axially magnetized NIB 52 magnet 108. However, a magnet of any suitable dimensions and strength may be utilized, as desired. At the direct opposite is a bass guitar pickup coil 110 with 7 thousand wraps of wire and 15 kohm resistance at DC. However, any suitable pickup or similar electronic components may be utilized, as desired. It will be appreciated that the pair of magnet 108 and pickup 110 create an incrementally engageable feedback loop which passes in parallel back to an amplifier. The feedback loop is created by a subject sitting forward or bouncing the C spring chair system 100, but primarily strongly increasing the amplitude of the chorus swell of the 1 Hz beat frequencies. When activated during 25 and 26 Hz constructive interference, the very augmented pattern is shown in FIG. 4B. This effect has a role in gamification, but especially in induced visceral vibration such as childbirth, bladder training, or appetite suppression.

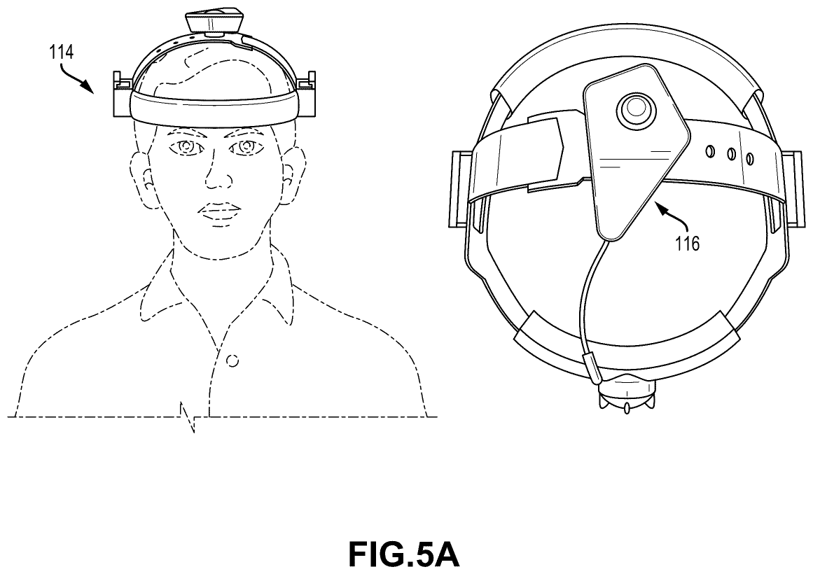

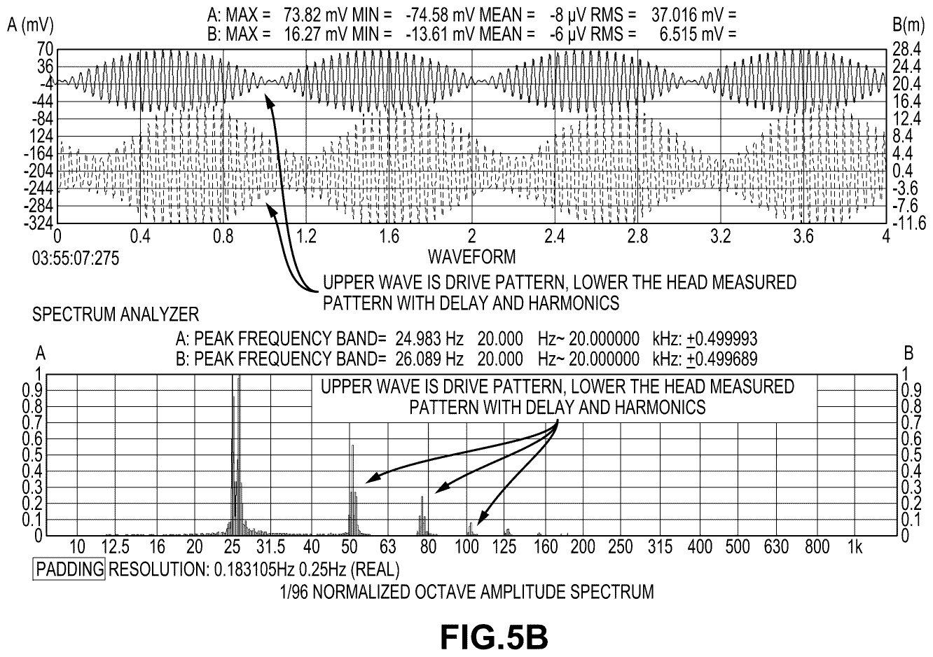

Turning now to FIGS. 5A and 5B, in accordance with various embodiments, FIG. 5A illustrates a wearable headband 114 which integrates a wireless piezo sensor 116 for detecting and monitoring a remote effect in the body of induced infrasonic-sonic waves. Headband 114 adjusts universally for height and tightness to allow accurate transduction. FIG. 5B shows simultaneous tracings of induced swells in seat 102 and detection of a traversed waveform in the head. The head sensor 116 shows the expected delay as the waveform ascends the spine, but also increased harmonics due to the shaping effect of the spine to convert sinusoidal infrasonic waveforms into a more ramp-like waveform with a multiplicity of harmonics.

Thus, in accordance with various exemplary embodiments, the combination of a seat-configured effector of chorus vibrations straddling the infrasonic-sonic range of about 5 Hz to about 100 Hz can be shown to adapt to various target organs such as the brain, stomach, bladder, or gravid uterus for a range of therapeutic effects in the management of various conditions or diseases. The foregoing listing is illustrative rather than exhaustive. Exemplary devices and methods may be utilized for many other target effects anticipated in the field of “vibroceuticals.”

Benefits, other advantages, and solutions to problems have been described herein with regard to specific embodiments. Furthermore, the connecting lines shown in the various figures contained herein are intended to represent exemplary functional relationships and/or physical or communicative couplings between the various elements. It should be noted that many alternative or additional functional relationships or physical or communicative connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” or “at least one of A, B, and C” is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Methods, systems, and articles are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A C spring therapy chair system, comprising:
a seat coupled to a base via a C spring, the seat vibrationally isolated from the C spring;
a first low frequency effector (LFE) coupled to a first side of the seat;
a second LFE coupled to a second side of the seat, the first and second LFE positioned so as to be proximal to the ischial spines of the sacrum when a human subject is seated in the seat;
a magnet coupled to a first side of the C spring; and
a pickup coupled to a second side of the C spring.

2. The system of claim 1, further comprising a pair of handles coupled to the second side of the C spring, the pair of handles configured to allow the human subject to narrow and widen a gap between the magnet and the pickup via application of force to the handles when seated in the seat.

3. The system of claim 1, further comprising a piezo sensor mounted on a headband, the headband configured to be worn by the human subject during operation of the system to measure an effect of vibration of the seat on the human subject.

4. The system of claim 1, wherein the LFEs are configured to induce constructive and destructive interference waveforms into the seat, and wherein the seat imparts these effects into the seated human subject.

5. The system of claim 1, wherein the LFEs are configured to be driven (i) by single frequencies to create a summating interference effect, and (ii) by 2-4 further frequencies straddling the infrasonic to auditory sonic range of 5 Hz to 100 Hz, creating patterns of chord structure.

6. The system of claim 1, wherein a parallel path of amplitude modulation into the chair from the LFEs can be induced using the magnet and the pickup by narrowing or strumming an aperture of the C spring.

7. A method, comprising:
utilizing the system of claim 1 to induce chorus vibration at a portion of the body of the human subject, wherein the induced chorus vibration has a therapeutic effect.

8. The method of claim 7, wherein the therapeutic effect is at least one of: suppression of appetite through the humeral (endocrine) pathway, suppression of appetite through the vagal nerve pathway, augmenting the birthing reflex, bladder training, or reduction of addicted craving.

9. The method of claim 7, further comprising:
using (i) a computer based real time visual rendering of patterns of traversing phased chorus waveforms at the portion of the body, and (ii) the human subject's interactive engagement with the system, to provide at least of one of local or remote feedback to the human subject during operation of the system.

10. The method of claim 9, wherein the chorus vibration at the portion of the body is measured with at least one of an accelerometer, piezo sensor, or magnetometer.

11. The method of claim 7, wherein the chorus vibration is a major chord.

12. The method of claim 7, wherein the chorus vibration is a minor chord.

13. The method of claim 7, wherein the chorus vibration can be perceived and measured through a combination of infrasonic and auditory sonic energy transmission pathways through the body of the human subject, including stretch mechanoreceptors in skin, muscles, joints, tendons, visceral organ linings, and bone conduction to the cochlea.
